(19) United States
(12) Patent Application Publication
(10) Pub. No.: US 2025/0350079 A1
(43) Pub. Date: Nov. 13, 2025

(54) CONNECTOR ADAPTER

(71) Applicant: Deere & Company, Moline, IL (US)

(72) Inventor: Henry C. Olsen, Bettendorf, IA (US)

(73) Assignee: Deere & Company, Moline, IL (US)

(21) Appl. No.: 18/922,579

(22) Filed: Oct. 22, 2024

Related U.S. Application Data
(60) Provisional application No. 63/646,214, filed on May 13, 2024.

(51) Int. Cl. H01R 31/06

(52) U.S. Cl. CPC H01R 31/06; H01R 2201/26

(57) ABSTRACT

A connector adaptor includes a housing having an inlet portion configured to receive a first connector from an in-cylinder position sensor and an outlet portion configured to receive a second connector. The first connector and second connector are push to connect connectors. The connector adapter includes an electrical connector interface within the housing. The electrical connector interface can convert an electrical connection of a first pin configuration to an electrical connection of a second pin configuration, wherein the first pin configuration has a different number of pins than the second pin configuration. The connector adaptor can be a right-angle or straight connector.

### RELATED APPLICATION DATA

This application claims priority to U.S. Patent Application No. 63/646,214 filed on May 15, 2024, which is incorporated herein by reference.

### BACKGROUND

Cylinders are employed in many different industrial vehicles, such as graders. Sensors are often to use to sense operating conditions of the cylinders, such as the position and velocity of the cylinder piston. The sensors typically include a connector interface for connecting the sensor to a monitoring system. For example, connectors can be used for making electrical connections to an In-Cylinder Position Sensor. However, connectors for one application may not be suitable for use in another application. For example, an industrial connector, such as for a cylinder sensor is not designed for operation in mobile off-highway applications. Certain connectors can be difficult to connect in manufacturing environments. For instance, the connector may include a threaded connection that is difficult to tighten because of restricted access to the connector. For instance, an operator with an assembler with a glove on their hand may have difficult tightening the connector and ultimately the connector may not be sufficiently tightened. The connector may also include internal features like pins that can be difficult to align.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a connector adapter. The connector adaptor may include a housing having an inlet portion configured to receive a first connector from an in-cylinder position sensor and an outlet portion configured to receive a second connector. The first connector and second connector may be push to connect connectors. The connector adapter may include an electrical connector interface within the housing. The electrical connector interface can convert an electrical connection of a first pin configuration to an electrical connection of a second pin configuration, wherein the first pin configuration has a different number of pins than the second pin configuration.

In another implementation, a connector adaptor may include an electrical connector interface. The electrical connector interface can convert an electrical connection of a first pin configuration to an electrical connection of a second pin configuration, wherein the first pin configuration has a different number of pins than the second pin configuration. The connector adaptor may also include a housing for holding the electrical connector interface. The housing may include an inlet portion configured to receive a first connector from an in-cylinder position sensor and having the first pin configuration. The connector adaptor may also include an outlet portion holding configured to receive a second connector with the second pin configuration. The connector adapter may include a flange having a hole arranged to align with a hole in a hydraulic cylinder and to secure the housing to a hydraulic cylinder.

In yet another implementation, a connector adaptor assembly may include a flexible printed circuit board having a first circuit board in communication with a second circuit board. The first circuit board may be adapted for a first pin configuration, and the second circuit board may be adapted for a second pin configuration. The first pin configuration may have a different number of pins than the second pin configuration. The connector adaptor assembly may also include a housing for holding the flexible printed circuit board. The housing may include an inlet portion holding the first circuit board and configured to receive a first connector in communication with an in-cylinder position sensor in a hydraulic cylinder. The first connector can have the first pin configuration. The inlet portion may include a flange configured to secure the housing to the hydraulic cylinder. The flange may have a hole arranged to align with a hole in a hydraulic cylinder for receiving a fastener to secure the housing to the hydraulic cylinder. The housing may also include an outlet portion holding the second circuit board and configured to receive a second connector with the second pin configuration. The outlet portion includes a bulkhead configured to hold pins extending form the second circuit board in a consistent position. The connector adaptor assembly may also include a washer plate having an open end to receive the inlet portion and a cutout corresponding to the hole in the flange. The washer plate includes a groove for receiving a rib on the inlet portion. The inlet portion may be angled 90 degrees relative to the outlet portion. The inlet portion may be configured to couple to the first connector with a snap-fit connection, and the outlet portion may be configured to couple to the second connector with a push to connect connection.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating an example implementation of a vehicle in which various examples of the connector adapter can be implemented.

FIG. 2 illustrates an example of a hydraulic cylinder in which the connector adaptor can be implemented.

FIG. 3A is an exploded view of the right angle connector adaptor illustrating one implementation of the electrical connector interface in which the flexible-rigid printed circuit board is shown connected to the M12 socket carrier.

FIG. 3B is an exploded view of the right angle connector adaptor illustrating one implementation of the electrical connector interface in which the flexible-rigid printed circuit board is shown separated from the M12 socket carrier.

FIG. 3C is an exploded view of the right angle connector adaptor illustrating a second implementation of the electrical connector interface in which the flexible-rigid printed circuit board is shown connected to the M12 socket carrier.

FIG. 4A is a front perspective view of the right angle connector adaptor.

FIG. 4B is a rear perspective view of the right angle connector adaptor.

FIG. 5 is a front view of the right angle connector adaptor.

FIG. 6 is a right side view of the right angle connector adaptor.

FIG. 7A is a right side view of the right angle connector adaptor showing the cross-section of line A-A.

FIG. 7B is a right side view of the right angle connector adaptor coupled to the sensor connector showing the cross-section of line A-A.

FIG. 8 is a rear view of the right angle connector adaptor.

FIG. 9 is a left side view of the right angle connector adaptor.

FIG. 10 is a top view of the right angle connector adaptor.

FIG. 11 is a bottom view of the right angle connector adaptor.

FIG. 12A is an exploded view of a straight connector adaptor in which the electrical connector interface is shown connected to the M12 socket carrier.

FIG. 12B is an exploded view of the straight adaptor in which the electrical connector interface is shown separated from the M12 socket carrier.

FIG. 13A is a front perspective view of the straight connector adaptor.

FIG. 13B is a rear perspective view of the straight connector adaptor.

FIG. 14 is a front view of the straight connector adaptor.

FIG. 15 is a right side view of the straight connector adaptor.

FIG. 16A is a right side view of the straight connector adaptor showing the cross-section indicated by line B-B.

FIG. 16B is a right side view of the straight connector adaptor coupled to the sensor connector showing the cross-section indicated by line B-B.

FIG. 17 is a rear view of the straight connector adaptor.

FIG. 18 is a left side view of the straight connector adaptor.

FIG. 19 is a top view of the straight connector adaptor.

FIG. 20 is a bottom view of the straight connector adaptor.

FIG. 21 is a perspective view of the electrical connector interface.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, relating to one or more connector adapter arrangements may be suitable for use in different applications, such as for connector application in different off-highway applications, such as agricultural applications. That is, the herein disclosed examples can be implemented with different connection arrangements for adapting a connector to connector to a sensor device, such as a cylinder sensor. Moreover, while one or more examples are described in connection with adapting a particular connector for electrical connection, the herein described examples are applicable to other connectors.

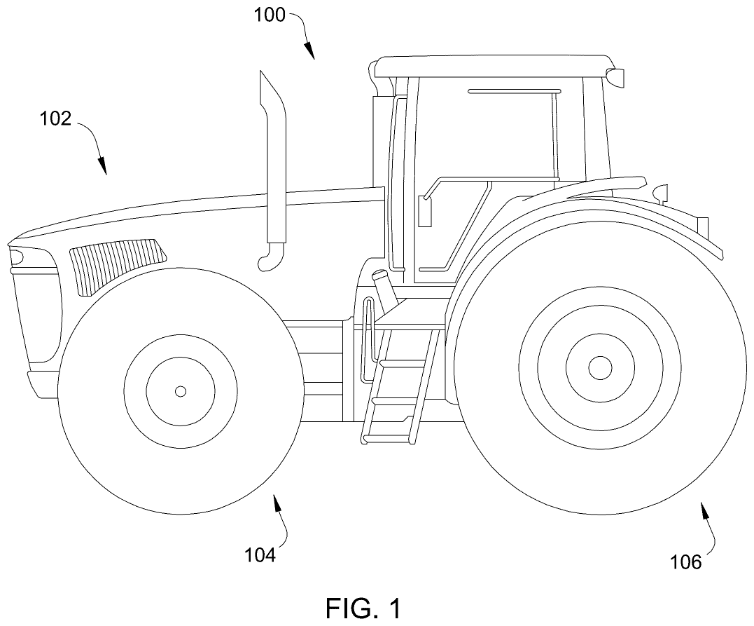

FIG. 1 is a component diagram illustrating an example implementation of a system that may utilize one or more portions of the aspects and examples described herein. In the implementation illustrated in FIG. 1, a vehicle 100, such as a tractor, can perform different operations, such as a ground working operation in a field. In some implementations, the vehicle 100 has wheels 104, 106 installed thereon. In other implementations, the vehicle 100 has track systems (not shown) instead of wheels installed on the rear or both the front and rear of the vehicle 100.

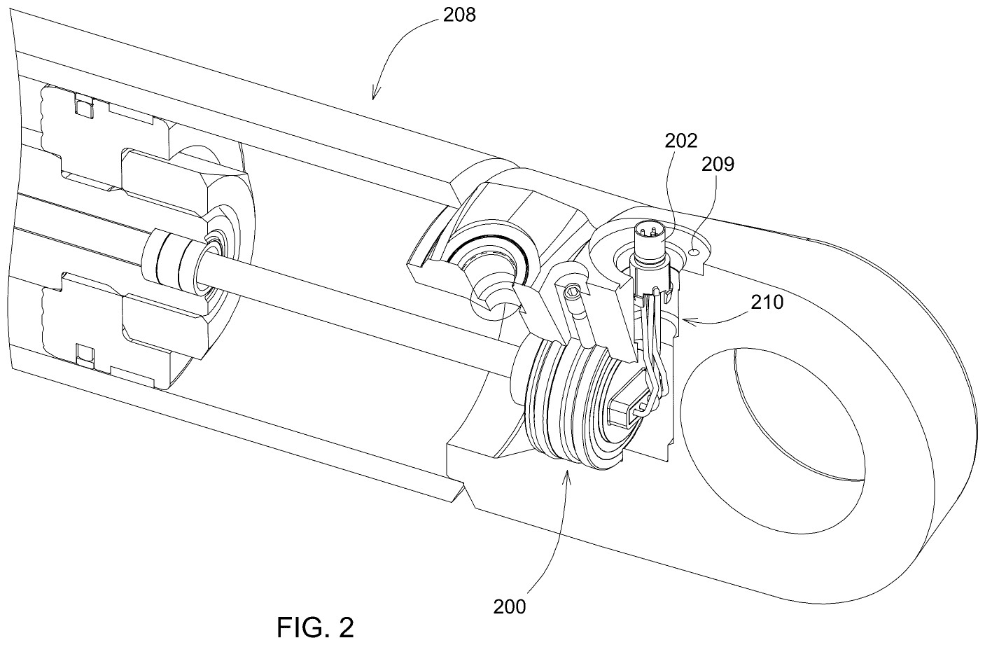

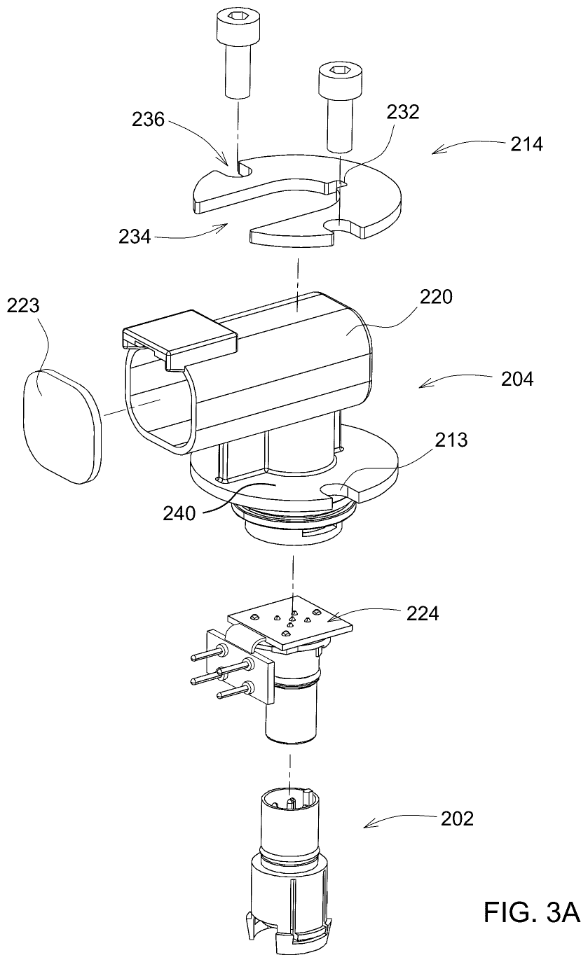

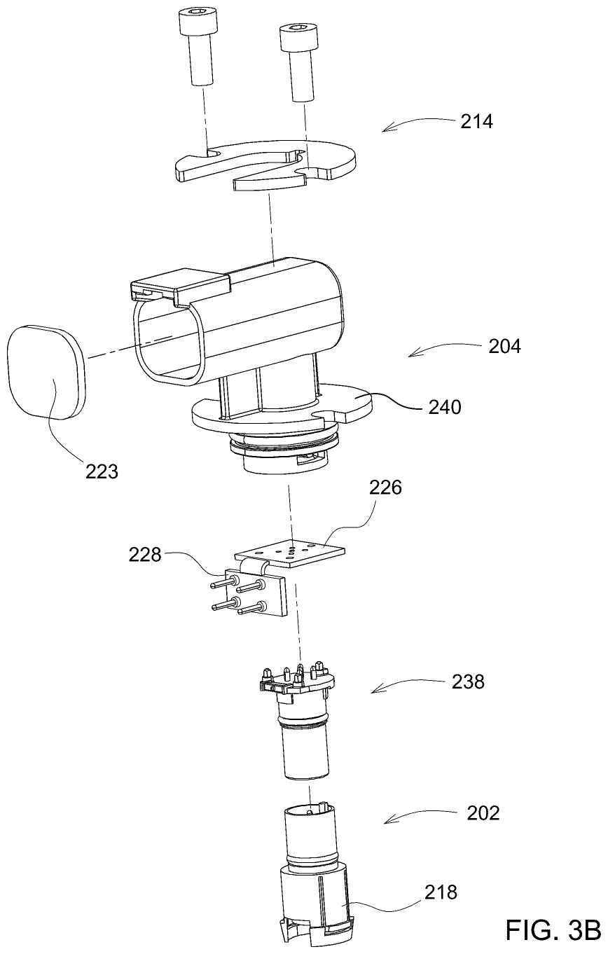

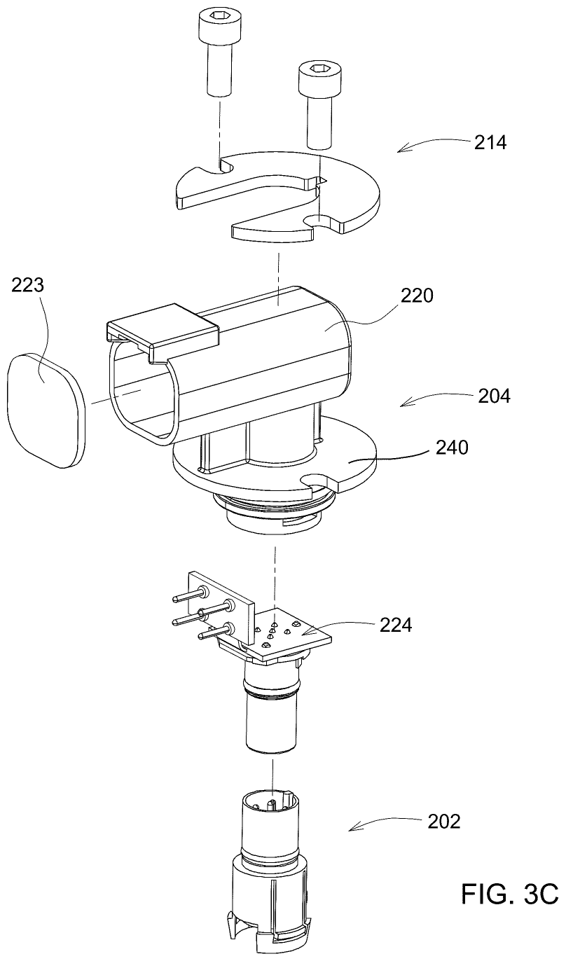

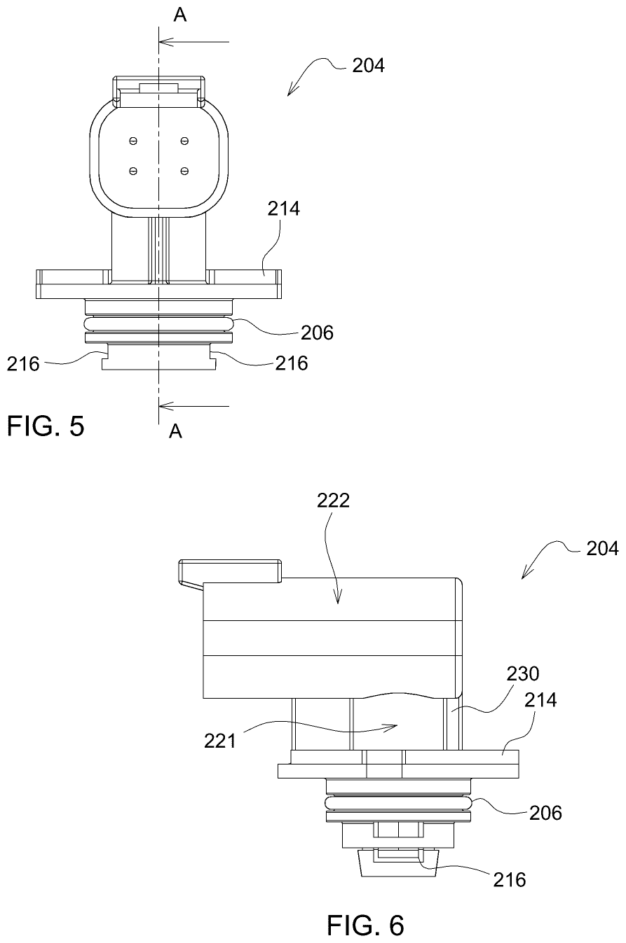

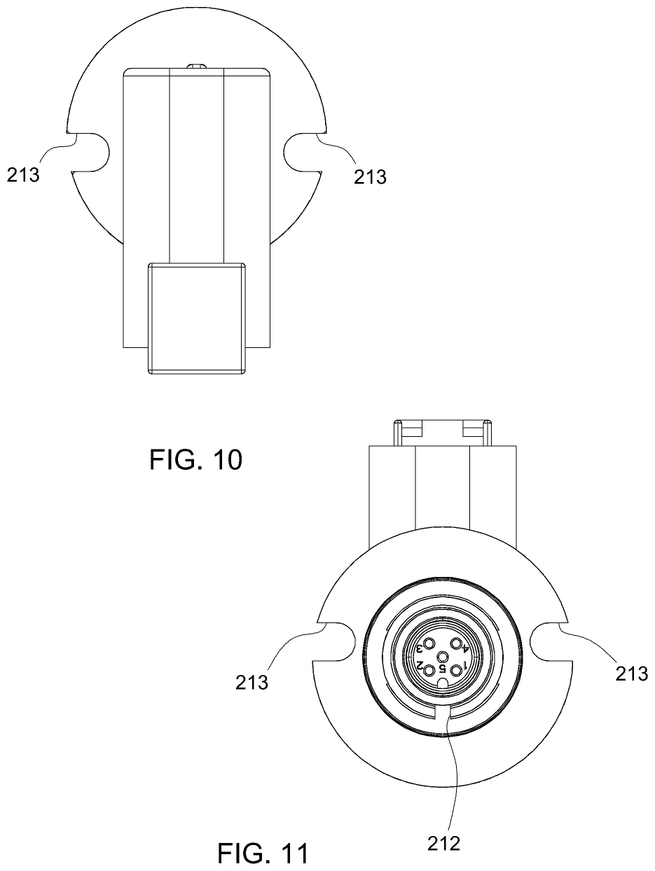

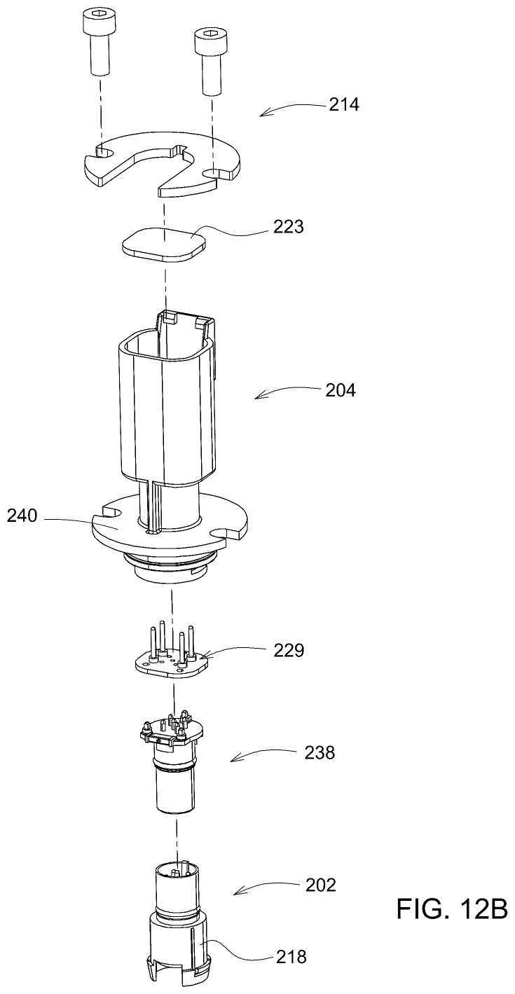

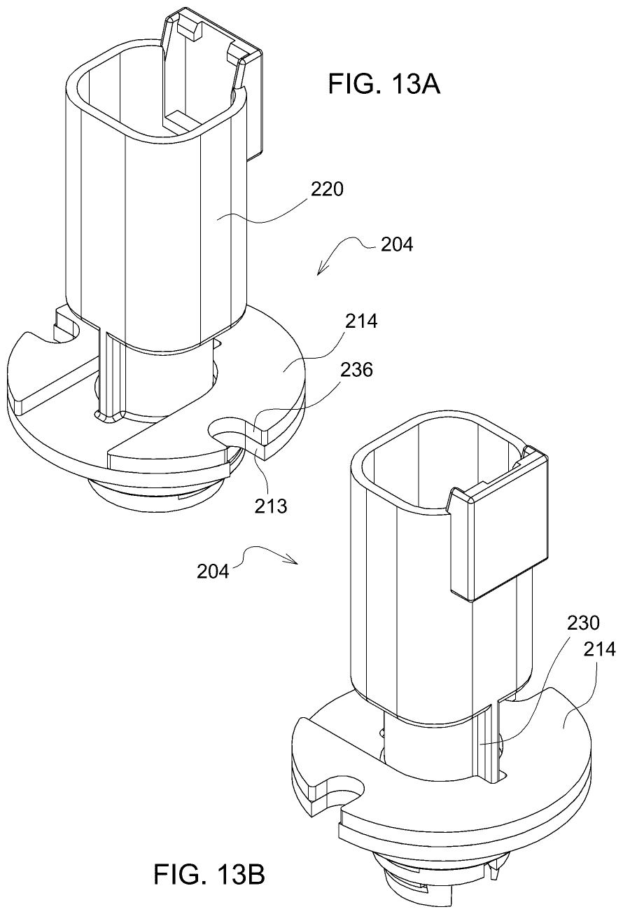

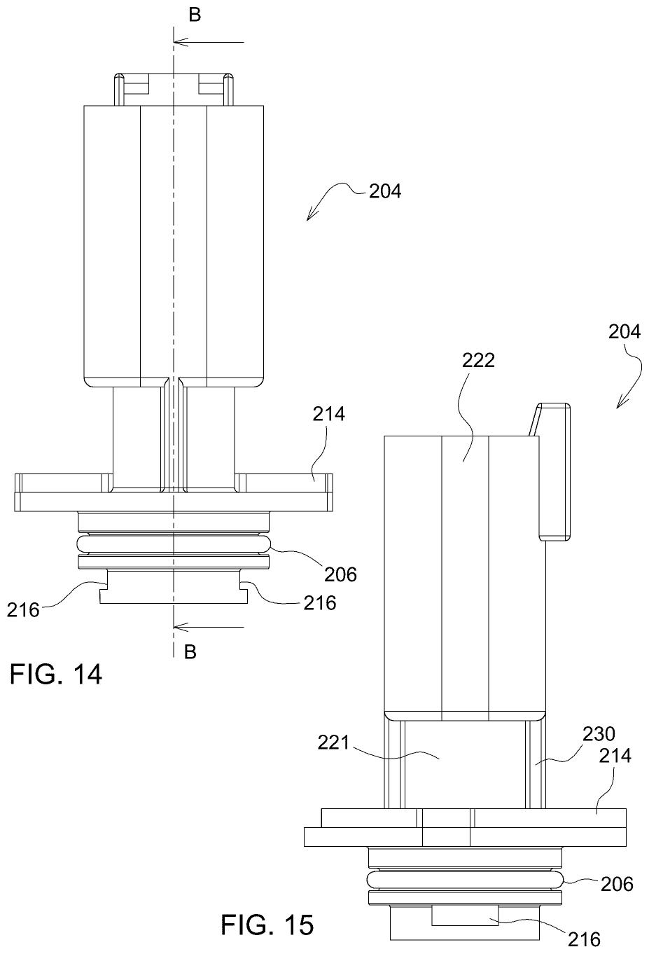

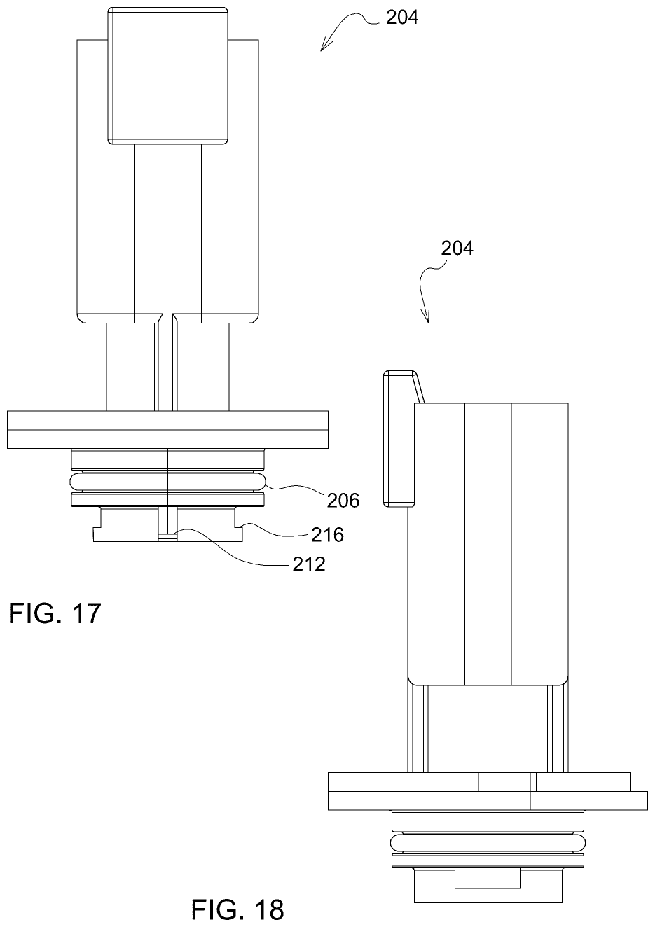

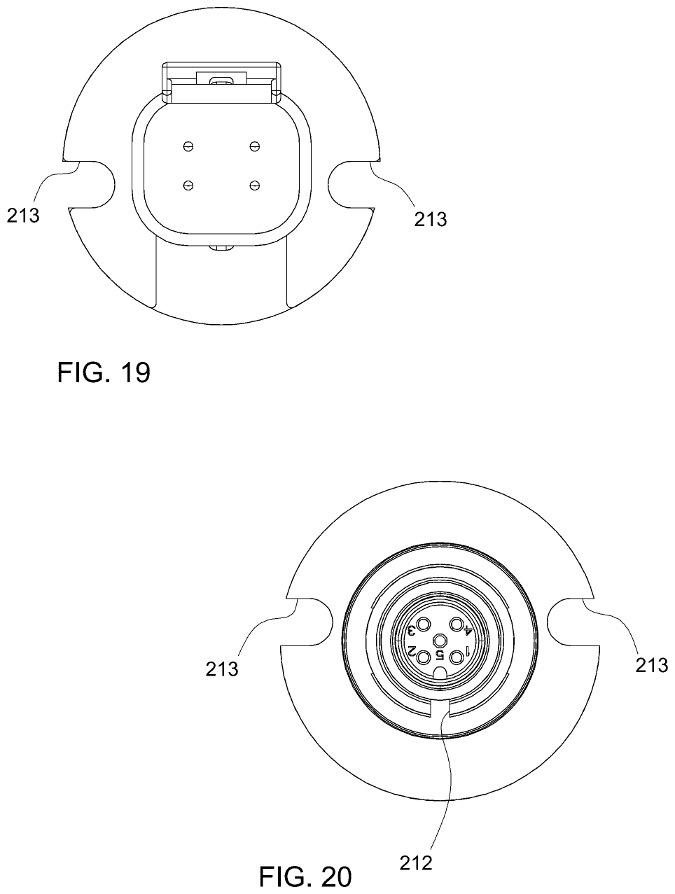

The vehicle 100 includes a chassis 102, which provides attachment points for the vehicle 100. For example, a work tool (e.g., a bucket, fork, blade, auger, or hammer) can be connected to the front or back of the chassis 102. The work tool is movably connected to the chassis 102 in some examples. In one or more examples, the vehicle 100 includes or is operable with an implement that uses one or more hydraulic cylinders having associated sensors. The sensors can provide various details related to the operation of the hydraulic cylinders, including position, velocity, temperature, and pressure. In one particular example, the sensor is an in-cylinder position sensor 200 with a sensor connector 202 having an M12 configuration (defined by international standard IEC61076-2-101) as illustrated in FIG. 2. In various implementations, an adaptor 204 (see also FIGS. 3A-11 and FIGS. 12A-20) is configured to adapt the sensor connector 202 to a different connection arrangement (e.g., a different electrical pin connector arrangement). In the illustrated example, the adaptor 204 is configured to transform M12, 4-pin and 5-pin connectors (such as sold by in-cylinder sensor manufacturers, for example, Temposonics and Hydac), to a 4-pin connector configuration (e.g., a Deutsch DT family connection system). That is, the adaptor 204 transforms the pin connection configuration from one type to a different type. Generally, the adaptor 204 allows for easier assembly because it provides a push to connect connection and does not change any specifications of the existing sensor. For instance, the adaptor 204 connects to the existing sensor connector 202, and the existing sensor wires do not need to be lengthened, shortened, or changed in any other way.

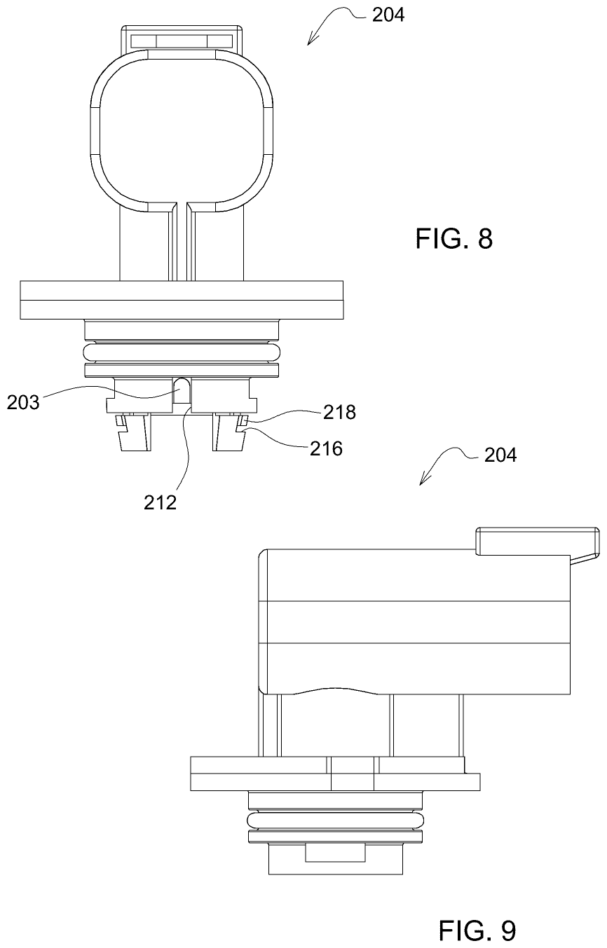

In various examples, a seal 206 seals a cylinder wiring cavity 210 of a cylinder 208 using the same sealing arrangement (e.g., O-ring seal) and cylinder cavity configuration as an existing part (e.g., John Deere M12 connector housing/flange part AHC21722). In other words, the adaptor 204 is configured such that it has substantially the same dimensions within the cylinder wiring cavity 210 as the existing connector when it is installed. This prevents overpacking of the cylinder wiring cavity 210 that can cause damage to the sensor wires. As can further be seen in FIG. 8, a notch 212 is provided in a base of the adaptor 204 for alignment that is configured to accept a projection 203 that extends radially outward on the sensor connector 202. That is, the notch 212 ensures proper connection alignment between the adaptor 204 and the sensor connector 202 by preventing the sensor connector 202 from fully mating with the adaptor 204 unless the projection 203 is received in the notch 12. In another example, the center plane for one or more screw fastening holes 213 in a flange 240 of the base of the adaptor 204 is offset from the M12 connector and O-ring center axis to ensure correct, one-way assembly in the cylinder cavity 210. As illustrated, the one or more screw fastening holes 213 may be slotted holes having an open end that extends to the edge of a base of the adaptor 204. Alternatively, the one or more holes 213 can be closed slotted holes or circular holes.

Additionally, a washer plate 214, such as a steel washer plate, is coupled to or engages the adaptor 204 such that the washer plate 214 abuts an upper surface of the flange 240 at the base of the adaptor 204. The washer plate 214 further includes one or more fastening cutouts 236 that align with one or more holes 209 in the cylinder body when the adaptor 204 is properly aligned. The one or more fastening cutouts 236 in the washer plate are configured to receive a mechanical fastener like a screw or bolt. The one or more holes 209 in the cylinder body may be threaded holes configured to receive the mechanical fastener. It will be appreciated that the number of the one or more holes 209 in the cylinder body, one or more holes 213, and one or more cutouts 236 may be equal. For instance, there may be two holes 209 in the cylinder body, two holes in the flange 240, and two cutouts 236 in the washer plate 214. The holes 209 may be aligned and symmetrically spaced across the cylinder cavity 210 in a first plane, but offset asymmetrically in a second plane orthogonal to first plane. This arrangement ensures the adaptor 204 can be oriented to ensure proper wire routing. As illustrated, the washer plate 214 has an open end 234 configured to accept the adaptor 204. The washer plate 214 reduces screw fastener contact stresses applied to the plastic molded flange 240 at the base of the adaptor 204. Alternatively, the need for the washer plate 214 may be replaced by metallic inserts or bushings, not shown in any figures, fitted to the flange 240 in the location of at least one holes 213.

The sensor connector 202 and the adaptor 204 may be coupled together with a catch and latch or snap-fit connection. A pair of complementary openings 216 on the adaptor 204 may be configured to engage features on the sensor connector 202 to provide the snap-fit connection. For example, the openings 216 in one example are a pair of molded notches to engage a pair of living hinge latches 218 on the sensor connector 202. The living hinge latches 218 may be deflectable cantilevered arms with a hook that engage the openings 216.

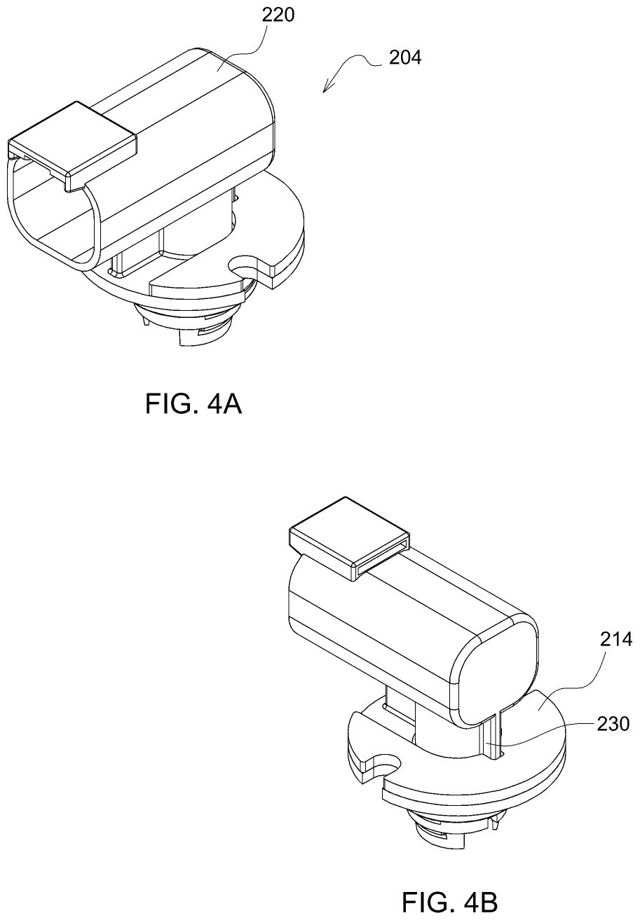

In the illustrated example, the adaptor 204 has a right angle (90°) connector configuration adapted for machine wire routings to in-cylinder position sensors in various examples. However, other configurations of adaptor 204 are contemplated, such as a straight configuration (without the angle), or other angle configurations. As can be seen particularly in FIGS. 4A-11, a housing 220 (e.g., an over molded receptacle housing) includes an inlet connector portion 221 and an end connector portion 222. As illustrated, the inlet connector portion 221 is oriented at a 90-degree angle relative to the end connector portion 222. It will be appreciated that the inlet connector portion 221 can be oriented at other angles between 90 degrees and 180 degrees relative to the end connector portion 222. The end connector portion 222 may be configured as a Deutsch DTM04 receptacle to engage Deutsch DTM06 connectors. As can be seen in FIGS. 4B and 6, the inlet connector portion 221 may also include a rib 230 projected out from the surface of the inlet connector portion 221 and extending the length of the inlet connector portion. A groove 232 in the washer plate 214 is configured to receive the rib 230 and further ensures the adaptor 204 is properly aligned when installed. A bulkhead 223 may be disposed within the end connector portion 222. The bulkhead 223 may be configured hold the pins in the end connector portion 222 in a consistent position to ensure proper alignment when connecting the adaptor 204 to a connector, like a Deutsch DTM06 connector. The bulkhead 223 may be made of epoxy or potting compound. Alternatively, the bulkhead 223 could be molded around the pins contained in the end connector portion 222 through injection molding when the housing 220 is made.

To install the adaptor 204, the adaptor 204 can be coupled to the sensor connector 202 by aligning the openings 216 on the adaptor 204 with the living hinge latches 218 on the sensor connector 202 and pushing them together until the openings 216 and living hinge latches 218 snap together when they are properly engaged. The sensor connector 202 and the base of the adaptor 204 can be placed into the cylinder wiring cavity 210 in an orientation such that the one or more holes 213 in the flange 240 the adaptor 204 align with one or more holes 209 in the cylinder 208. The seal 206 at the base of the adaptor should sealingly engage with the cylinder wiring cavity 210. The washer plate 214 can be installed by placing the washer plate 214 over the base of the adaptor 204 such that the inlet connector portion 221 is received within the open end 234 of the washer plate 214, the rib 230 is received in the groove 232 of the washer plate 214, and the one or more fastener cutouts 236 align with the one or more holes 213 in the flange 240 of the adaptor 204 and the one or more holes 209 in the cylinder 208. A mechanical fastener, like a bolt or a screw, may be inserted into the one or more fasteners cutout 236, the one or more holes 213 in the flange 240 of the adaptor 204, and the one or more holes 209 in the cylinder 208, and fastened to secure the adaptor 204 in place.

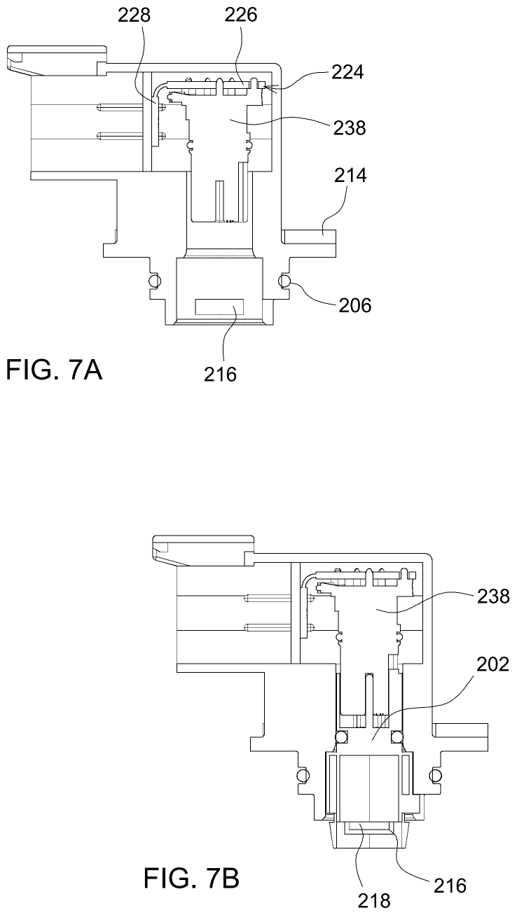

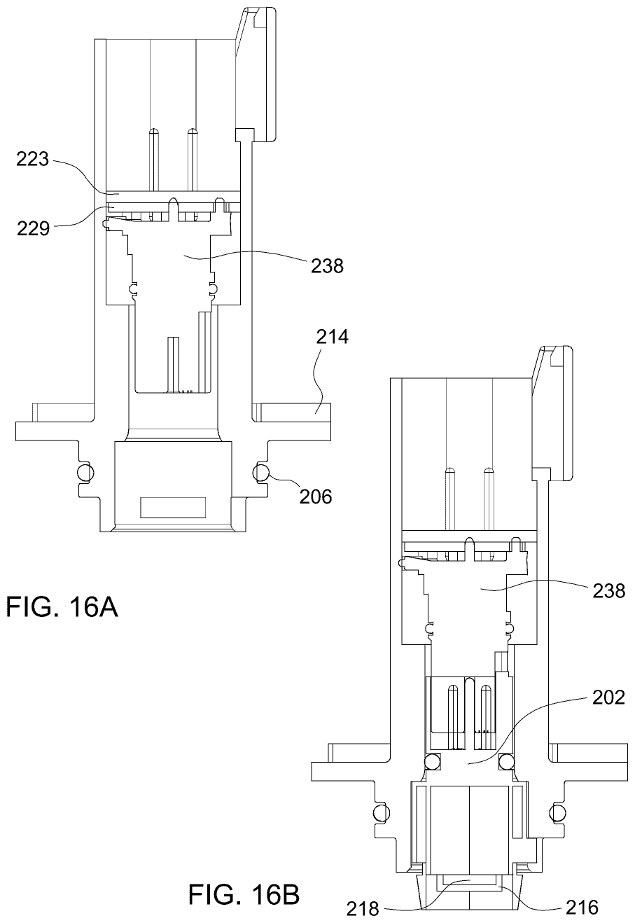

In various examples, an electrical connector interface 224 (see particularly FIGS. 7A, 7B, 16A, and 16B) is positioned within the housing 220. The electrical connector interface is configured to provide the pin conversion or transformation as described in more detail herein. In one example, the electrical connector interface is a rigid-flexible printed circuit board assembly (rigid-flex PCBA) 224 that converts a 5-pin connection 226 to a 4-pin connection 228. The rigid-flex PCBA 224 allows for the pins to be soldered to the circuit board, for instance with wave soldering. The rigid-flex PCBA 224 can be bent to a desired angle after soldering. For instance, as illustrated, the rigid-flex PCBA 224 can be bent so that an input circuit board of the rigid-flex PCBA 224 is oriented at an angle of 90 degrees relative to an output circuit board of the rigid-flex PCBA 224. It will be appreciated that in other implementations, the angle of the bend may range from 20 degrees to 180 degrees depending on the housing 220 of the adaptor 204. The angle of bend and the corresponding angle of the housing 220 can be determined by sound engineering judgement and the specific use on the vehicle 100 based on access to the cylinder and wiring best practices. An M12 socket carrier 238 may be disposed within the inlet connector portion 221 of the adaptor 204 and soldered to the input circuit board of the rigid-flex PCBA 224. The M12 socket carrier 238 is configured to couple to the sensor connector 202 to provide communication between the sensor connector 202 and the rigid-flex PCBA 224. In one implementation, as shown in FIGS. 3A and 3B, the five pins of the M12 socket carrier 238 may be soldered to the top of 5-pin connection 226 of the rigid-flex PCBA 224. In this configuration, the 4-pin connection 228 is bent toward the M12 socket carrier and extends below 5-pin connection 226 and the height of the socket carrier and rigid-flex PCBA is minimized. In an alternative implementation, as shown in FIG. 3C, the five pins of the M12 socket carrier 238 may be soldered to the bottom of 5 pin connection 226 of the rigid-flex PCBA 224. In this configuration, the 4-pin connection 228 is bent away from the M12 socket carrier and extends above the 5-pin connection 226.

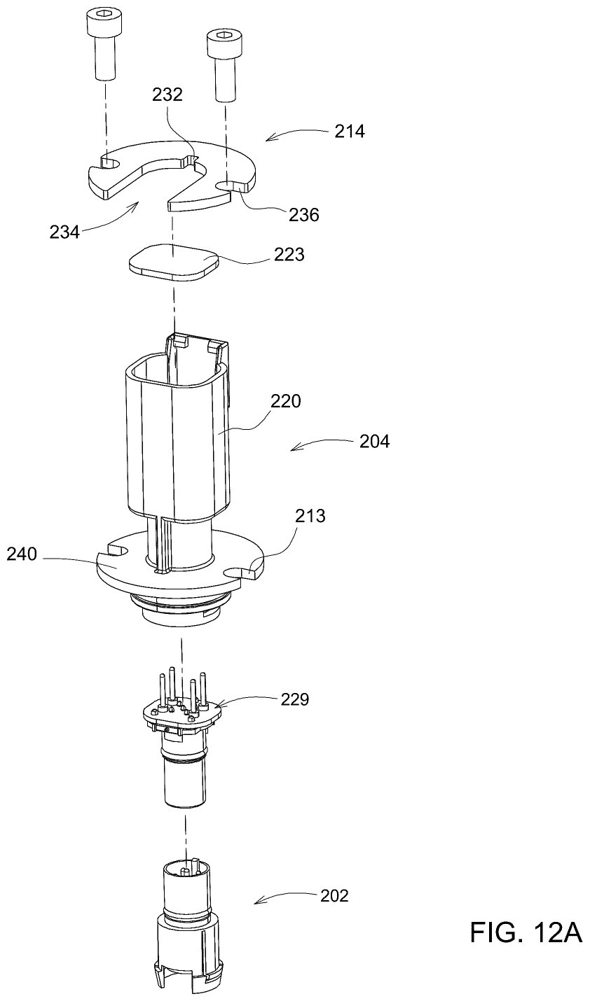

In another implementation, the housing 220 of the adaptor 204 may also be a straight housing as illustrated in FIGS. 12A-20. In this configuration, the electrical connector interface may be a printed circuit board 229. As shown in FIGS. 12A and 12B, the printed circuit board 229 may be configured to convert a 5-pin connection to a 4-pin connection. The pins from the input connection may be soldered to a first side of the printed circuit board 229 and the pins from the output connection may be soldered to a second side of the printed circuit board 229. For example, the five pins of the M12 socket carrier may be soldered to the first side of the printed circuit board 229 and the 4-pins of the Deutsch DTM04 receptacle may be soldered to the second side of the printed circuit board 229.

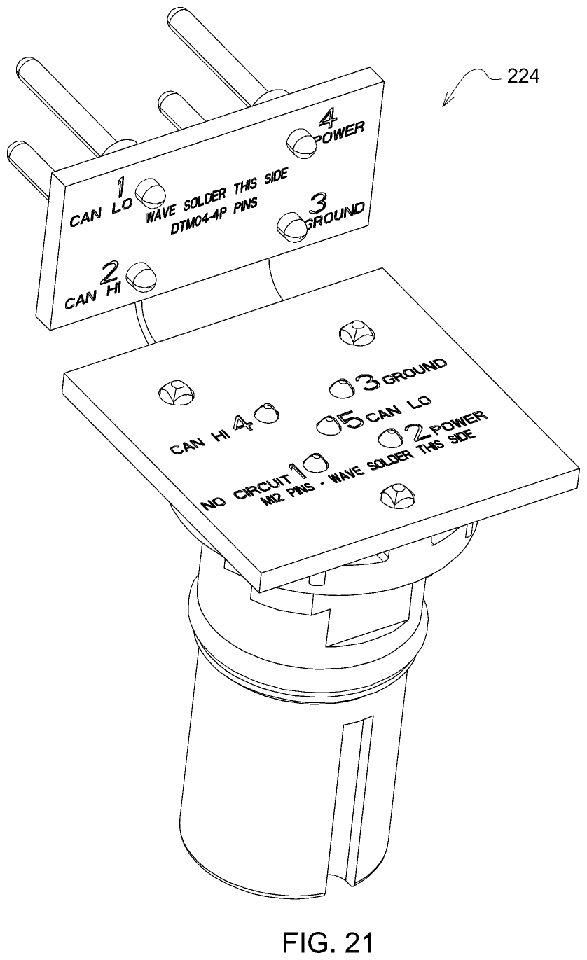

As can be seen in FIG. 21, the electrical pin interconnections are routed to ensure proper connection between different inputs and outputs, illustrated as CAN LO, CAN HI, POWER, AND GROUND. These illustrated circuit names are for a Controller Area Network (CAN) sensor. In another implementation, the pins and associated wiring could be configured to transmit no signal, an analog voltage, an analog current, a digital signal, or any other suitable signal. The rigid-flexible PCBA 224 and the printed circuit board 229 can be designed to accommodate different pin mapping configurations. For example, in one implementation, an input circuit board may have pins I1, I2, I3, I4, and I5 and an output circuit board may have pins O1, O2, O3, and O4. The pins may be connected to each other through the rigid-flexible PCBA 224 and the printed circuit board 229 such that I1 is connected to O1, I2 is connected to O2, I3 is connected to O3, I4 is connected to O4, and I5 is not used. The unused pin may be soldered to the input circuit board to strengthen the connection between the circuit board and the M12 socket carrier within the housing 220. In another implementation, the pins may be connected to each other through the rigid-flexible PCBA such that I1 is connected to O4, I2 is connected to O3, I3 is connected to O2, I4 is connected to O1, and I5 is not used. It will be appreciated the rigid-flexible PCBA 224 and the printed circuit board 229 can accommodate other pin mappings. For example, as illustrated, the rigid-flex PCBA 224 maps the five pins of an M12 socket carrier 238 to the four pins of a Deutsch DTM04 receptacle.

Thus, various examples provide an improved adaptor. The improved adaptor is configured to connect to existing sensor connectors in hydraulic cylinder assemblies with minimal change to the hydraulic cylinder assembly. The improved adaptor provides easy to install and consistent push to connect connections. The improved adaptor can be a right-angle adaptor or a straight connector.

According to an aspect, a connector adaptor is provided. The connector adaptor includes a housing having an inlet portion configured to receive a first connector from an in-cylinder position sensor and an outlet portion configured to receive a second connector. The first connector and second connector may be push to connect connectors. The connector adapter includes an electrical connector interface within the housing. The electrical connector interface converts an electrical connection of a first pin configuration to an electrical connection of a second pin configuration, wherein the first pin configuration has a different number of pins than the second pin configuration.

In an example, the first pin configuration is an M12 pin arrangement and the second pin configuration is a DTM04 connection arrangement.

In another example, the inlet portion of the housing has the M12 pin arrangement and the outlet portion of the housing has the DTM04 connection arrangement.

In another example, the connector adaptor includes a seal and a flange arrangement configured to sealingly secure the adaptor in a cavity of a hydraulic cylinder.

In another example, the flange arrangement includes a hole for aligning the housing relative to a hole in the hydraulic cylinder and receiving a mechanical fastener to secure the housing to the hydraulic cylinder.

In another example, the housing includes an inlet portion having a notch configured to receive a projection extending radially outward from a sensor connector.

In another example, the connector adaptor includes a washer plate configured to engage the flange arrangement. The washer plate may have an open end configured to receive an inlet portion of the housing and a cutout configured to receive a mechanical fastener to secure the housing to the hydraulic cylinder.

In another example, the washer plate includes a groove configured to receive a rib extending out from the inlet portion of the housing.

In another example, the electrical connector interface is a flexible printed circuit board.

In another example, the flexible printed circuit board has a first circuit board in communication with a second circuit board, the first circuit board having the first pin configuration and the second circuit board having the second pin configuration,

In another example, the inlet portion is angled relative to the outlet portion.

In another example, the inlet portion is angled at 90-degree angle relative to the outlet portion.

In another example, the electrical connector interface is a printed circuit board.

In another example, the housing is a straight configuration.

In another example, the housing includes a bulkhead for holding the first pin configuration or the second pin configuration in a consistent position.

According to another aspect, a connector adaptor includes an electrical connector interface. The electrical connector interface converts an electrical connection of a first pin configuration to an electrical connection of a second pin configuration, wherein the first pin configuration has a different number of pins than the second pin configuration. The connector adaptor also includes a housing for holding the electrical connector interface. The housing includes an inlet portion configured to receive a first connector from an in-cylinder position sensor, the first connector having the first pin configuration, an outlet portion holding configured to receive a second connector with the second pin configuration, and a flange having a hole arranged to align with a hole in a hydraulic cylinder and to secure the housing to a hydraulic cylinder.

In another example, the inlet portion includes openings configured to receive living hinge latches on the first connector, wherein the inlet portion couples to the first connector with a snap-fit connection.

In another example, the inlet portion includes a notch configured to receive a projection extending radially outward from the first connector to ensure alignment. When the first connector is properly aligned with and coupled to the housing, the notch receives the projection.

In another example, the hole in the flange is arranged offset a center axis of the inlet portion and the first connector to ensure proper alignment and installation of the housing.

According to yet another aspect, a connector adaptor assembly includes a flexible printed circuit board having a first circuit board in communication with a second circuit board. The first circuit board is adapted for a first pin configuration, and the second circuit board is adapted for a second pin configuration. The first pin configuration has a different number of pins than the second pin configuration. The connector adaptor assembly also includes a housing for holding the flexible printed circuit board. The housing includes an inlet portion holding the first circuit board and configured to receive a first connector in communication with an in-cylinder position sensor in a hydraulic cylinder. The first connector has the first pin configuration. The inlet portion includes a flange configured to secure the housing to the hydraulic cylinder. The flange having a hole arranged to align with a hole in a hydraulic cylinder for receiving a fastener to secure the housing to the hydraulic cylinder. The housing also includes an outlet portion holding the second circuit board and configured to receive a second connector with the second pin configuration. The outlet portion includes a bulkhead configured to hold pins extending form the second circuit board in a consistent position. The connector adaptor assembly also includes a washer plate having an open end to receive the inlet portion and a cutout corresponding to the hole in the flange. The washer plate includes a groove for receiving a rib on the inlet portion. The inlet portion is angled 90 degrees relative to the outlet portion. The inlet portion is configured to couple to the first connector with a snap-fit connection, and the outlet portion is configured to couple to the second connector with a push to connect connection.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this implementation. It is intended to include all such modifications and alterations in so far as they come within the scope of the appended claims or the equivalents thereof.

What is claimed is:

1. A connector adaptor, comprising:
a housing having an inlet portion configured to receive a first connector from an in-cylinder position sensor and an outlet portion configured to receive a second connector, the first connector and second connector being push to connect connectors; and
an electrical connector interface within the housing, the electrical connector interface converting an electrical connection of a first pin configuration to an electrical connection of a second pin configuration, wherein the first pin configuration has a different number of pins than the second pin configuration.

2. The connector adaptor of claim 1, wherein the first pin configuration is an M12 pin arrangement and the second pin configuration is a DTM04 connection arrangement.

3. The connector adaptor of claim 2, wherein the inlet portion of the housing has the M12 pin arrangement and the outlet portion of the housing has the DTM04 connection arrangement.

4. The connector adapter of claim 1, further comprising a seal and a flange arrangement configured to sealingly secure the adaptor in a cavity of a hydraulic cylinder.

5. The connector adaptor of claim 4, the flange arrangement comprising a hole for aligning the housing relative to a hole in the hydraulic cylinder and receiving a mechanical fastener to secure the housing to the hydraulic cylinder.

6. The connector adaptor of claim 1, the housing further comprising an inlet portion having a notch configured to receive a projection extending radially outward from a sensor connector.

7. The connector adaptor of claim 4, further comprising a washer plate configured to engage the flange arrangement, the washer plate having an open end configured to receive an inlet portion of the housing and a cutout configured to receive a mechanical fastener to secure the housing to the hydraulic cylinder.

8. The connector adaptor of claim 7, the washer plate further comprising a groove configured to receive a rib extending out from the inlet portion of the housing.

9. The connector adaptor of claim 1, wherein the electrical connector interface is a flexible printed circuit board.

10. The connector adaptor of claim 9, wherein the flexible printed circuit board has a first circuit board in communication with a second circuit board, the first circuit board having the first pin configuration and the second circuit board having the second pin configuration.

11. The connector adaptor of claim 10, wherein the inlet portion is angled relative to the outlet portion.

12. The connector adaptor of claim 11, wherein the inlet portion is angled at 90-degree angle relative to the outlet portion.

13. The connector adaptor of claim 1, wherein the electrical connector interface is a printed circuit board.

14. The connector adaptor of claim 13, wherein the housing is a straight configuration.

15. The connector adaptor of claim 1, the housing comprising a bulkhead for holding the first pin configuration or the second pin configuration in a consistent position.

16. A connector adaptor, comprising:
an electrical connector interface, the electrical connector interface converting an electrical connection of a first pin configuration to an electrical connection of a second pin configuration, wherein the first pin configuration has a different number of pins than the second pin configuration;
a housing for holding the electrical connector interface, the housing comprising:
an inlet portion configured to receive a first connector from an in-cylinder position sensor, the first connector having the first pin configuration;
an outlet portion holding configured to receive a second connector with the second pin configuration; and
a flange having a hole arranged to align with a hole in a hydraulic cylinder and to secure the housing to a hydraulic cylinder.

17. The connector adaptor of claim 16, the inlet portion comprising openings configured to receive living hinge latches on the first connector, wherein the inlet portion couples to the first connector with a snap-fit connection.

18. The connector adaptor of claim 16, the inlet portion comprising a notch configured to receive a projection extending radially outward from the first connector to ensure alignment, wherein when the first connector is properly aligned with and coupled to the housing, the notch receives the projection.

19. The connector adaptor of claim 16, wherein the hole in the flange is arranged offset a center axis of the inlet portion and the first connector to ensure proper alignment and installation of the housing.

20. A connector adaptor assembly, comprising:
a flexible printed circuit board having a first circuit board in communication with a second circuit board, the first circuit board adapted for a first pin configuration and the second circuit board adapted for a second pin configuration, wherein the first pin configuration has a different number of pins than the second pin configuration; and
a housing for holding the flexible printed circuit board, the housing comprising:
an inlet portion holding the first circuit board and configured to receive a first connector in communication with an in-cylinder position sensor in a hydraulic cylinder, the first connector having a first pin configuration, the inlet portion having a flange configured to secure the housing to the hydraulic cylinder, and the flange having a hole arranged to align with a hole in a hydraulic cylinder for receiving a fastener to secure the housing to the hydraulic cylinder;
an outlet portion holding the second circuit board and configured to receive a second connector with the second pin configuration, the outlet portion having a bulkhead configured to hold pins extending form the second circuit board in a consistent position; and
a washer plate having an open end to receive the inlet portion and a cutout corresponding to the hole in the flange, the washer plate having a groove for receiving a rib on the inlet portion,
wherein inlet portion is angled 90 degrees relative to the outlet portion and the inlet portion configured to couple to the first connector with a snap-fit connection and the outlet portion is configured to couple to the second connector with a push to connect connection.
